(19) United States
(12) Patent Application Publication
(10) Pub. No.: US 2009/0320089 A1
(43) Pub. Date: Dec. 24, 2009

(54) POLICY-BASED USER BROKERED AUTHORIZATION

(75) Inventors: Matthew G. Lyons, Palatine, IL (US); Scott R. Shell, Kirkland, WA (US); Yadhu N. Gopalan, Issaquah, WA (US); Neil R. Coles, Redmond, WA (US); John S. Camilleri, Bothell, WA (US); Loren Kohnfelder, Redmond, WA (US); Andrew M. Rogers, Bellevue, WA (US); Sha Viswanathan, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/143,666

(22) Filed: Jun. 20, 2008

(51) Int. Cl. G06F 21/20

(52) U.S. Cl. 726/1

(57) ABSTRACT

A User Brokered Authorization (UBA) mechanism for policy decisions in a computing device is provided. The authorization mechanism interacts with an authorization layer of the computing device's operating system and enables a determination of whether an authorization decision can be made programmatically or by end user decision based on generalized device policy.

### BACKGROUND

A mobile device managed by an organization is typically configured and controlled by a management service to ensure compliance. The mobile device may connect periodically over the air to the management service and send/receive management related information during a management session such as send status, send inventory, receive configuration, or receive policy. Furthermore, a number of third party applications may be loaded and executed on the mobile device that may access a number of resources managed or controlled by the management service. Thus, security decisions may need to be made when an application on the mobile device requests access to a resource.

Some security decisions cannot be made programmatically in a way that corresponds to the desired behavior of an end user because a computing application typically lacks information about the situation and the end user. This may result in scenarios where a computing device requires an end user to make authorization decisions explicitly. For example, dialog boxes may be used to ask users to decide whether or not to run a program module in conjunction with a web browser function. In some operating systems, the user with the administrative rights may be required to make some of those decisions.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to a User Brokered Authorization (UBA) of policy decisions. An authorization mechanism according to some embodiments interacts with an authorization layer of the operating system and enables a determination of whether an authorization decision can be made programmatically or by end user decision based on generalized device policy.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating an example mobile device and an example architecture of a User Brokered Authorization (UBA) mechanism;

FIG. 2 illustrates a diagram of how an example UBA system works with steps between various components according to one embodiment;

FIG. 3 illustrates another diagram of how an example UBA system works according to another embodiment;

FIG. 4 illustrates a networked environment where embodiments may be implemented;

FIG. 5 is a block diagram of an example computing operating environment, where embodiments may be implemented; and

FIG. 6 illustrates a logic flow diagram for a process of implementing a UBA mechanism in a computing device according to embodiments.

### DETAILED DESCRIPTION

As briefly discussed above, a user brokered authorization mechanism may interact with an authorization layer of an operating system and enable a determination of whether an authorization decision can be made programmatically or by end user decision based on generalized device policy. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

While mobile computing devices are mentioned as an example operating environment for implementations of a policy-based user brokered authorization system, embodiments are not so limited. A User Brokered Authorization (UBA) system according to embodiments may be implemented in any networked computing device including, but not limited to, desktop computers, laptop computers, smart phone devices, networked personal assistants, smart automobile consoles, and the like using the principles described herein.

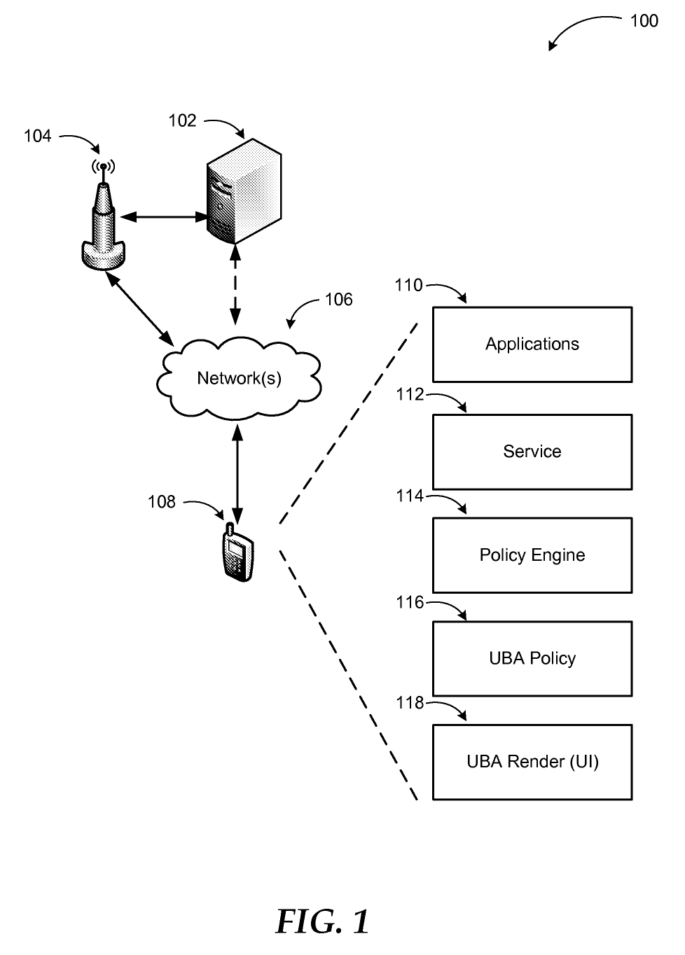

Referring to FIG. 1, diagram 100 of an example mobile device and an example architecture of a UBA mechanism is illustrated, where users are presented with decisions regarding security and privacy. With the proliferation of networked mobile devices and service providers, management of these devices such as their configuration, network compatibility, permitted service features, security concerns for accessing of resources, and so on, have become a challenging aspect.

Existing security prompting schemes generally require specific User Interface (UI) display code to be written for each prompting situation. A UBA system according to embodiments makes a determination based on policy and requires no additional code to display the prompt. Any authorization check may be allowed to become a security prompt based on policy settings. Services that perform authorization checks may be allowed to provide arbitrary context information to the UI display code so that UI elements can be configured by policy to include custom information for that type of prompt.

Computing devices managed by a system according to embodiments may communicate over a variety of networks. Such networks may include those known as cellular networks (e.g. GSM, CDMA), local or wide area networks (LAN, WAN), or the newer Unified Communication Networks (UCN), which integrate multiple communication systems (for example the Office Communication System® by MICROSOFT CORP. of Redmond, Wash.).

In the conceptual diagram 100 of FIG. 1, mobile device 108 is shown as communicating (and being managed by) server 102 of a management service over network (s) 106. Network(s) 106 may include at least one of the above mentioned network or others. Server 102 may communicate with mobile device 108 through a transceiver 104 (such as cell tower, access point, etc.) or directly.

In a system according to embodiments, applications 110 may reside on the computing device 108 or be executed in a shared manner at a server and accessed by the computing device 108. Service 112 is associated with at least one resource that may be needed by the applications 110. Service 112 may also provide protection services such as checking permissions of a user/device before allowing access to a resource. Thus, service 112 may interact with policy engine 114 to determine authorization results based on existing policies.

In a system according to one embodiment, UBA policy module 116 may be placed between policy engine 114 and UBA render layer(s) 118 of a UBA prompt stack for rendering user interface elements when a user is to be prompted for authorization decision. The UBA render layer is an ‘output’ of the UBA policy module, which decides whether or not to display a prompt to the user. From this point, UBA render layer 118 is responsible for creating a prompt window, waiting for results, and signaling back to UBA policy module 116.

Through the interaction between the above described components, the results of a prompt that has been rendered may be interpreted. If the user selects a persistence option in the UI, UBA policy module is responsible for authoring rules to a policy database that suppresses future prompts. Caller hard timeouts may also be implemented. In some cases, UBA callers may specify a hard timeout within which the user must answer a prompt. This may be necessary when the user is prompted while holding a system resource. Moreover, prompts may be queued as they are issued from the policy engine 114. UBA policy module 116 may effectively act as a prompt scheduler. If two “pop-up” prompts occur at the same time, one may be blocked until the first prompt completes so as not to inundate the user. If two prompts occur for the same resource, and the first is answered with “do not ask me again”, UBA policy module may suppress the second prompt, while returning the user's decision from the first prompt to both callers.

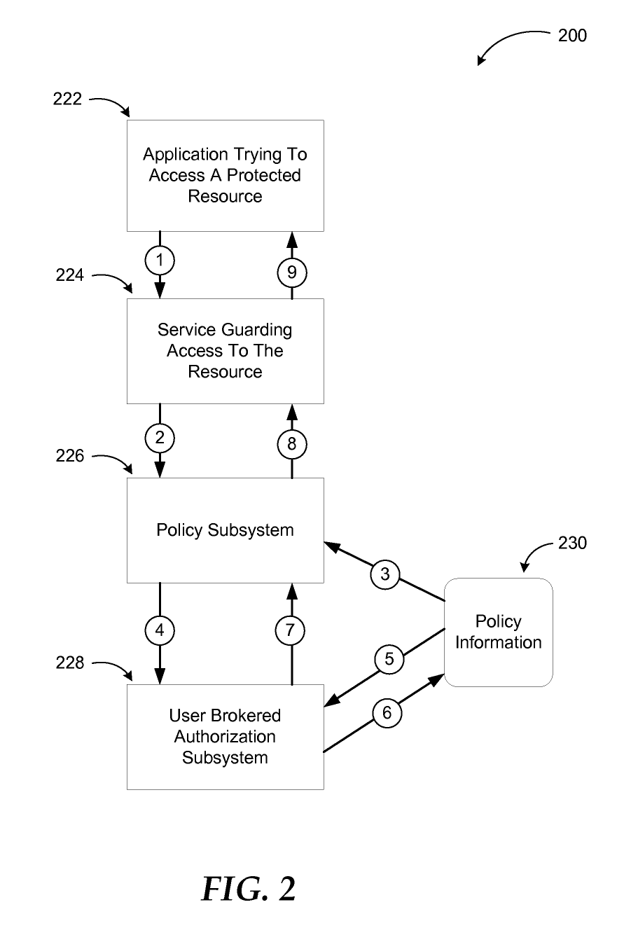

FIG. 2 illustrates a diagram of how an example UBA system works with steps between various components according to one embodiment. As shown in diagram 200, one external component of the UBA system according to embodiments is an application 222 trying to access a protected resource in step 1. The protected resource may be a resource on the computing device (e.g. user data), a resource accessible through a network by the computing device (e.g. data or application permitted to be accessed by the user), or an action to be completed by the computing device (e.g. placement of a call).

The next component is a service protecting the resource being attempted to be accessed 224. The service/subsystem protecting the resource or providing the protected resource to the application may check a policy to determine if the application should be granted the ability to access the resource. When calling into the policy subsystem to make this check, the service may pass down context data such as ID of the calling application, network location the application is trying to access, details of the underlying network connection to be used to establish a connection to the requested network location, and the like, in step 2.

In step 3, policy subsystem 226 receives policy information from a policy information source (e.g. a database) 230 and determines what the policy outcome should be based on the context provided and. The policy subsystem 226 passes through the context data from the calling service and adds any additional context data that UBA subsystem 228 might use to UBA subsystem 228 in step 4. If the policy dictates that the user should be prompted, then the policy subsystem may call into the UBA subsystem to prompt the user.

In step 5, the UBA subsystem 228 reads additional policy information and evaluates it in concert with the context data to determine exact UI elements (e.g., icons, text, buttons, etc.) to display to the user. It then displays the UI elements to the user and updates context data to return to the service 224. If the end user decides to persist his/her decision by interacting through the UI, the UBA subsystem 228 may store the end user's decision in policy information source 230 to avoid future prompts as shown in step 6.

The UBA subsystem 228 then returns the end user's decision and context data to the policy subsystem 226 in step 7, which returns the UBA subsystem's decision and context data to the service 224. The service 224 returns the appropriate result to the application depending on the scenario and context data. The manner the result is returned to the application may vary depending on the interface between the application and the service.

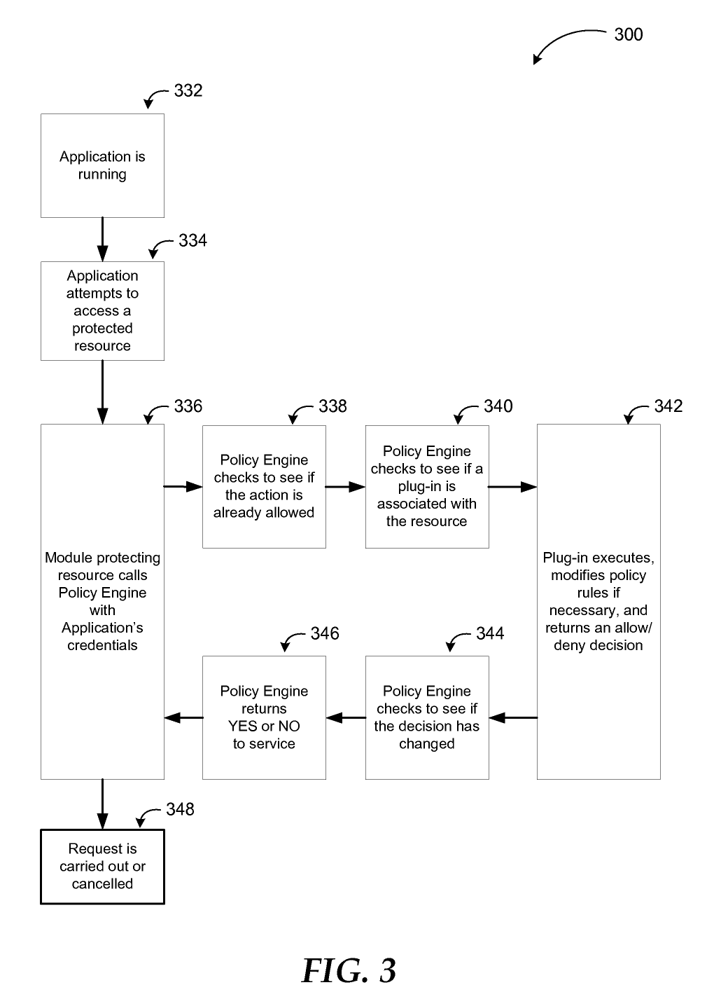

FIG. 3 illustrates another diagram of how an example UBA system works according to another embodiment. In the example operation 300, an application is being executed 332 on a computing device with policies for authorization. When the application attempts to process a protected resource 334 such as accessing a networked resource, initiating a communication session, accessing information protected for security or privacy reasons, and the like, the module protecting the resource call the policy engine with the application's credentials 336. The policy engine checks to determine is the action is already allowed 338. If the action is not readily allowed, the policy engine checks to determine is a plug-in module is associated with the resource 340. If there is a plug-in associated with the resource, the plug-in modifies policy rules if necessary, and returns a decision comprising one of an allowance or a denial 342.

Upon receiving the decision from the plug-in module, the policy engine checks to see if the decision has changed (e.g. due to an update) 344 and returns the decision to the module (or service) protecting the resource 346. The application's request to access the resource may then be carried out or cancelled depending on whether the decision was to allow or to deny access 348.

While the example components and operations in FIGS. 1, 2, and 3 have been described with specific components, embodiments are not limited to these components, interactions between the components, or system configurations and may be implemented with other system configuration employing fewer or additional components. Functionality of the systems enabling programmatic or end user decision-based authorization employing generalized device policy may also be distributed among the components of the systems differently depending on component capabilities and system configurations.

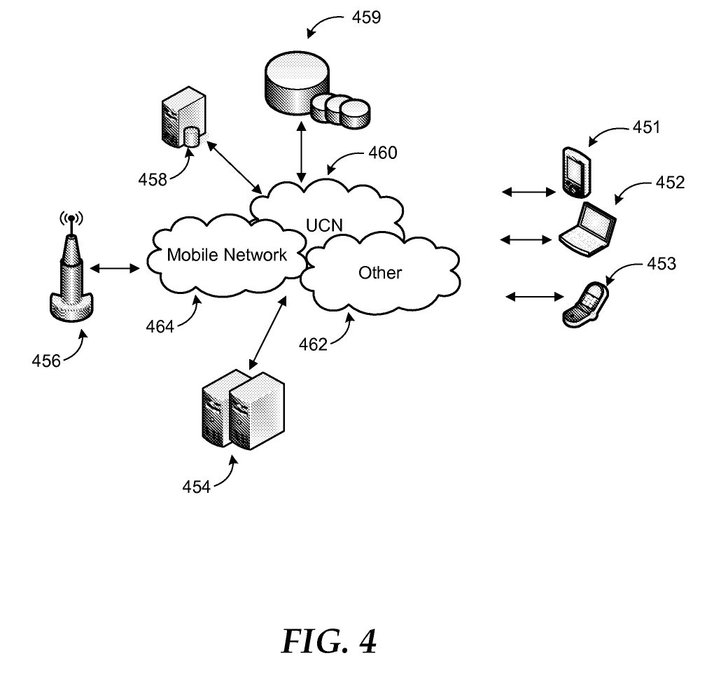

FIG. 4 is an example networked environment, where embodiments may be implemented. A UBA system such as those described previously may be implemented locally or in a distributed manner over a number of physical and virtual clients and servers. Such a system may typically involve at least one network of the same type or distinct such as UCN 460, Mobile Network 464, and other networks 462. The system may be implemented in un-clustered systems or clustered systems employing a number of nodes communicating over at least one network.

A system according to embodiments may comprise any topology of servers, clients, Internet service providers, and communication media. Also, the system may have a static or dynamic topology. The term “client” may refer to a client application or a client device (e.g. mobile device). While a policy-based user brokered authorization system may involve many more components, typical and relevant ones are discussed in conjunction with this figure.

Mobile devices 451, 452, and 453 may participate in a managed system over at least one of the networks 460, 462, and 464. Mobile devices 451, 452, and 453 may execute applications, locally or in a distributed manner, which may require access to a resource through one of the networks. Allowing access to the requesting application may present, in some cases, a security or privacy concern and be managed by policy engine enforcing user/device authorization policies. In a system according to embodiments, a UBA policy plug-in module interacts with a policy engine and UBA render layers for user interface rendering and enables a determination of whether an authorization decision can be made programmatically or by end user decision based on generalized device policy.

While example mobile devices such as smart phones, PDAs, laptop or handheld computers, etc., have been used as illustrative examples, embodiments are not limited to those. As mentioned previously, mobile communication may be implemented in purely software form as well, such as a client application that can be executed on any computing device. Since such a client application may be installed and executed on other types of computing devices such as a smart automobile console or even a desktop computer, embodiments may be implemented in those devices and others using the principles described herein. Data associated with the system and mobile device configuration may be stored in at least one data store such as data stores 459, which may be directly accessed by the servers and/or clients of the system or managed through a database server 458. The system may also employ additional servers for performing other specific tasks such as providing applications and/or resources to the mobile device(s). Mobile devices 451, 452, and 453 provide platforms for client applications. Thus, users may access at least one communication system using a client device or at least one client application running on a client device.

Networks 460, 462, 464 may include a secure network such as an enterprise network or a cellular network, an unsecure network such as a wireless open network, or the Internet. Networks 460, 462, 464 provide communication between the nodes described herein. By way of example, and not limitation, Networks 460, 462, 464 may include wired media such as a wired network or direct-wired connection, and wireless media such as acoustic, RF, infrared and other wireless media.

Many other configurations of computing devices, applications, data sources, data distribution systems may be employed to implement a policy-based user brokered authorization system. Furthermore, the networked environments discussed in FIG. 4 are for illustration purposes only. Embodiments are not limited to the example applications, modules, or processes.

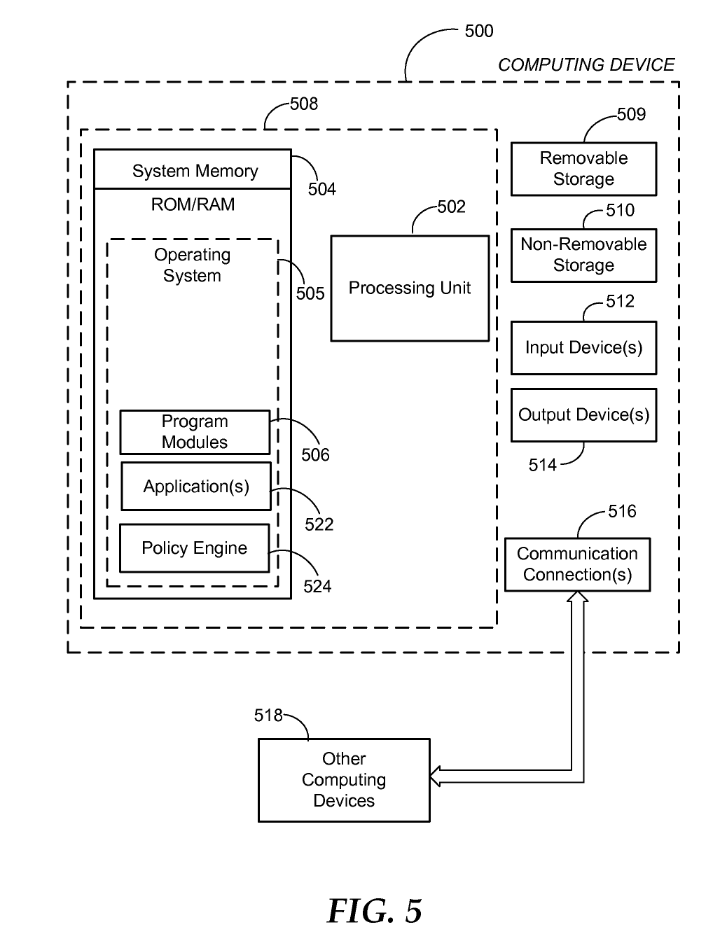

FIG. 5 and the associated discussion are intended to provide a brief, general description of a suitable computing environment in which embodiments may be implemented. With reference to FIG. 5, a block diagram of an example computing operating environment is illustrated, such as computing device 500. In a basic configuration, the computing device 500 may be a mobile device executing a number of applications and communicate through a managed network. Computing device 500 may typically include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the computing device, such as a version of the WINDOWS® operating systems from MICROSOFT CORPORATION of Redmond, Wash. The system memory 504 may also include at least one software application such as program modules 506, application(s) 522, and policy engine 524.

Application(s) 522 are executed on computing device 500 may require to access resources such as execution of a particular module for web browsing, initiating a communication session (e.g. a phone call), and the like. Policy engine 524 may be a separate module or an integral part of the device operating system for managing user/device policies and enforcing them. Policy engine 524 may work in conjunction with a UBA policy plug-in module and enable a determination of whether an authorization decision can be made programmatically or by end user decision based on generalized device policy. This basic configuration is illustrated in FIG. 5 by those components within dashed line 508.

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of device 500. Computing device 500 may also have input device(s) 512 such as keyboard, mouse, pen, voice input device, touch input device, etc. Output device(s) 514 such as a display, speakers, printer, etc. may also be included. These devices are well known in the art and need not be discussed at length here.

The computing device 500 may also contain communication connections 516 that allow the device to communicate with other computing devices 518, such as over a wireless network in a distributed computing environment, for example, an intranet or the Internet. Other computing devices 518 may include client devices of the managed network or a management server as discussed above. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has at least one of its characteristic set or changed in such a manner as to encode information in the signal. By way of example, and not limitation, communication media includes wired media such as a wired network or direct-wired connection, and wireless media such as acoustic, RF, infrared and other wireless media.

The claimed subject matter also includes methods. These methods can be implemented in any number of ways, including the structures described in this document. One such way is by machine operations, of devices of the type described in this document.

Another optional way is for at least one of the individual operations of the method to be performed in conjunction with at least one human operator performing some. These human operators need not be collocated with each other, but each can be only with a machine that performs a portion of the program.

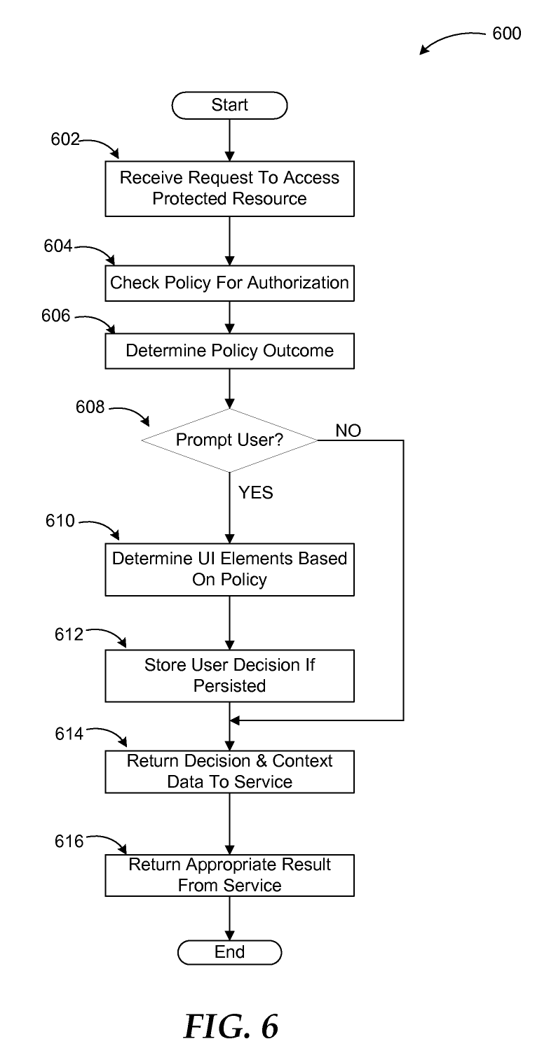

FIG. 6 illustrates a logic flow diagram for process 600 of implementing a UBA mechanism in a computing device according to embodiments. Process 600 may be implemented in a mobile device capable of communicating over a managed network.

Process 600 begins with operation 602, where a request for accessing a resource is received from an application executed on the mobile device. Processing continues to operation 604, where at least one policy is checked for authorization. The policies may dictate that a programmatic decision be made or the user to be prompted. The policies may be based on user, device, or network credentials. Processing advances to operation 606, where policy outcome is determined based on the credentials, context of the request, and so on.

Following operation 606, processing moves to decision operation 608, where a determination is made whether the user is to be prompted. If the user is to be prompted, processing continues to operation 610 where user interface elements to be used in the prompt are determined based on policy. At subsequent operation 612, the user decision is stored if the user has indicated the decision to be persisted.

Following operation 612 or a negative determination at decision operation 608, the decision and context data are returned to a service managing the protected resource at operation 614. The decision may be to allow or to deny access to the requested resource. Processing then advances to operation 616, where the appropriate result is returned from the service to the requesting application.

The operations included in process 600 are for illustration purposes. Policy-based user brokered authorization may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for employing policy-based user brokered authorization, the method comprising:
receiving a request for access to a resource associated with the computing device from an application executed on the computing device;
forwarding the request to a policy engine along with an application credential and context data;
determining, based on at least one policy, whether the request is to be programmatically evaluated;
if the request is to be programmatically evaluated determining whether to allow the request;
if the request is to be allowed based on the at least one policy, enabling the application access to the requested resource; else providing a denial response to the application.

2. The method of claim 1, further comprising:
if the request is not to be programmatically evaluated:
determining elements of a user interface for prompting a user based on the at least one policy;
rendering the user interface for prompting the user for a decision; and
returning a response to the application based on the user decision.

3. The method of claim 2, further comprising:
prompting the user to indicate whether the decision is to be persisted in the rendered user interface; and
if the decision is to be persisted, storing the decision and context data for future use.

4. The method of claim 2, further comprising:
enforcing a timeout upon prompting the user to provide a decision input.

5. The method of claim 1, further comprising:
determining whether to allow the request by modifying a portion of the at least one policy.

6. The method of claim 1, wherein the resource includes at least one from a set of: data stored on the computing device, data stored on a data store coupled to the computing device through a network, another application on the computing device, another application accessible through the network, and an operation associated with the computing device.

7. The method of claim 1, wherein the computing device includes at least one of: a mobile computing device, a desktop computing device, a laptop computing device, a smart automobile console, and a smart phone.

8. The method of claim 1, wherein the application is executed in a shared manner by a remote server in communication with the computing device through a network.

9. A mobile device for employing policy-based user brokered authorization (UBA), the mobile device comprising:
a memory;
a communication module; and
a processor coupled to the memory and the communication module, the processor configured to execute:
a local application arranged to:
provide a request for accessing at least one of a local resource and a networked resource to a service protecting the resource;
a policy engine arranged to:
receive the request along with an application credential and context data from the service;
retrieve at least one policy associated with the request from a policy database;
determine whether the request is to be evaluated by one of: an automatic decision process based on the at least one policy and a user decision;
if the request is to be evaluated by an automatic decision process, evaluate the request; and provide an evaluation result to the service; else
provide the request, the at least one policy, and the context data to a UBA module; and
the UBA module arranged to:
determine elements of a user interface for prompting the user based on the at least one policy and the context data;
render the user interface for prompting the user for a decision; and
return a response to the service based on the user decision.

10. The mobile device of claim 9, wherein the UBA module is further arranged to:
prompt the user in the rendered user interface to indicate whether the decision is to be persisted; and
if the decision is to be persisted, enable the policy engine to store the decision and context data at the policy database for future use.

11. The mobile device of claim 9, wherein the persisted decision includes one from a set of:
allowing access to the resource by the requesting application in the future;
denying access to the resource by the requesting application in the future;
allowing access to the resource by any requesting application in the future; and
denying access to the resource by any requesting application in the future.

12. The mobile device of claim 9, wherein the UBA module is further arranged to:
if a second request is received prior to completion of processing the request, blocking the second request until the response for the request is returned to the service.

13. The mobile device of claim 9, wherein the UBA module is further arranged to:
if at least two requests are received for a same resource and the user indicates the decision to be persisted for one of the requests, employing the same decision for the remaining requests and suppressing user prompts for the remaining requests.

14. The mobile device of claim 9, wherein the UBA module is further arranged to:
customize each user interface for prompting the user based on the at least one policy and the context data such that information relevant with each request is displayed in each corresponding user interface.

15. The mobile device of claim 9, wherein the elements of the user interface for prompting the user are retrieved from a networked location accessible by the mobile device.

16. The mobile device of claim 9, wherein the mobile device is one of: a smart phone, a Personal Digital Assistant (PDA), a laptop computer, a handheld computer, and a smart automobile console, and wherein the mobile device is capable of communicating through at least one from a set of: a cellular network, a Voice Over IP (VoIP) network, a Wireless Local Area Network (WLAN), a Wide Area Network (WAN), and a Unified Communications Network (UCN).

17. A computer-readable storage medium with instructions encoded thereon for employing policy-based user brokered authorization, the instructions comprising:
receiving a request for accessing at least one of a local resource and a networked resource by an application from a service protecting the resource, wherein the request includes an application credential and context data;
retrieving at least one policy associated with the request from a policy database;
determining whether the request is to be evaluated by one of: an automatic decision process based on the at least one policy and a user decision;
if the request is to be evaluated by an automatic decision process, evaluating the request and providing an evaluation result comprising one of: an allowance and a denial to the service;
if the request is to be evaluated by user decision process, determining elements of a user interface for prompting the user based on the at least one policy and the context data;
rendering the user interface for prompting the user for a decision;
prompting the user in the rendered user interface to indicate whether the decision is to be persisted;
if the decision is to be persisted, enable storage of the decision and context data at the policy database for future use; and
returning a response comprising one of: an allowance and a denial to the service based on the user decision.

18. The computer-readable storage medium of claim 17, wherein the instructions further comprise:
modifying the at least one policy based on the user decision.

19. The computer-readable storage medium of claim 17, wherein the elements of the user interface for prompting the user are configurable and stored in one of: a local and a remote data store.

20. The computer-readable storage medium of claim 17, wherein the instructions further comprise:
configuring the elements of the user interface for prompting the user through a centralized policy.
